(19) United States
(12) Patent Application Publication
(10) Pub. No.: US 2007/0177838 A1
(43) Pub. Date: Aug. 2, 2007

(54) Tapered roller bearing and tapered roller processing method

(76) Inventor: Takashi Tsujimoto, Iwata-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/572,281

(22) PCT Filed: Sep. 27, 2004
(86) PCT No.: PCT/JP04/14541

§ 371 Date: Dec. 5, 2006

(30) Foreign Application Priority Data
Oct. 1, 2003 (JP) 2003-343206

(51) Int. Cl. F16C 33/58

(52) U.S. Cl. 384/571

(57) ABSTRACT

The object of the present invention is to provide at low cost a long-life tapered roller bearing having a roller with a large crowning, which is preferred as a tapered roller bearing for supporting an automobile transmission pilot part. A peripheral surface of a roller 3 in a tapered roller bearing is crowning-processed by grinding and then finished by barrel polishing or tumble polishing in such a manner as to leave no grinding streaks.

### BACKGROUND OF THE INVENTION

1. Field of the invention

The present invention relates to a tapered roller bearing suitable for supporting for example an automobile transmission pilot part being used under significant misalignment and to a method for processing the tapered rollers thereof.

2. Description of the Background Art

FIG. 3 shows one example of a tapered roller bearing used in a typical manual transmission pilot part. The bearing has tapered rollers 3 held by a cage 4 and placed between an inner ring 1 and an outer ring 2. The inner ring 1 has a tapered raceway surface 1a and is provided with a large-collar surface 1b on the large-diameter side. The outer ring 2 is not an independent component, that is the inner surface of a gear constitutes the outer ring 2. The bearing for this part cannot be designed to be thick in cross section height H due to structural constraints of the transmission. However, since it is put under a heavy load condition and thus must have a large load capacity, the tapered roller bearing has wide bearing width with thin and long rollers 3. For example, the roller is of elongated shape in which the roller length is more than twice as long as the roller diameter.

Not being supplied by bearing manufacturers, in general, the inner surface of the outer ring 2 (the gear inner surface) is not provided with appropriate crowning for the bearing. Meanwhile, this kind of tapered roller bearing requires some anti-skew provision because of its significant misalignment and spindling rollers. Thus, as clearly indicated in FIG. 4 (A), a larger crowning than usual is applied to the peripheral surface of the roller 3. The crown-processed tapered roller 3 is tangent to the raceway surfaces 1a and 2a of the inner and outer rings 1 and 2 in certain contact area extending radially from in general at the middle portion of its longitudinal direction. A tangent position P may shift due to the deflection of an axis engaged in the inner surface of the inner ring 1.

Meanwhile, the roller 3 of the tapered roller bearing is driven and rotated during operation by the raceway surface 1a of the inner ring 1 or the raceway surface 2a of the outer ring 2. Sliding movement between a large end surface 3a of the roller 3 and a large collar surface 1b of the inner ring 1 constitutes a resistance generating part for counteracting the rotation of the roller 3.

As the tangent position P comes closer to small diameter side of the inner ring 1, a distance between the large collar surface 1b of resistance generating part and the tangent position P becomes longer. Thus, as shown in FIG. 4 (B), the tapered roller 3 is easily skewed (skew angleθ). This tendency comes to the fore as the roller 3 becomes longer.

In addition, in the event that misalignment occurs by axis deflection, the contact points on the inner ring 1 and the outer ring 2 to the tapered roller 3 may be separated on the small diameter side and the large diameter side as indicated with points P1 and P2 in FIG. 4 (A). In this case, the driving force acts directly as a force to skew the tapered roller 3.

The transmission's pilot part may have structurally a large amount of axis deflection resulting from gear loads. This would easily cause an angle error inside the bearing, which results in skewing of the roller 3. If the roller 3 is skewed, so-called galling occurs between the roller end surface 3a and the large collar surface 1b. In addition, if a slippage occurs between a rolling contact surface of the roller 3 and the raceway surfaces 1a and 2a of the inner and outer rings 1 and 2, which leads to peeling, smearing and even exfoliation. This can adversely affect the life of the bearing.

As for conventional tapered roller bearings, the following measures have been taken to address those issues: (1) providing a recess on the collar part; (2) applying a larger crowning to the roller; (3) using a split-type roller (see Japanese unexamined patent publication 2003-184885); (4) decreasing roughness of the raceway surface of the bearing ring, and increasing the amount of lubrication oil, and the like.

However, the bearing tends to be put under heavier load conditions, but it cannot be designed to be thick in cross section height H (FIG. 3) and thus only its width is made longer. Under such circumstances, the above listed measures may be inadequate to solve the problems.

For example, providing the roller with a crowning larger in size than a prescribed one would bring about unevenness in the roughness of the rolling contact surface, which makes the roller to be easily damaged on the surface (see Japanese unexamined patent publication 2003-172360). In addition, decreasing the roughness of the whole surface of the roller so as to be 0.4 μm or less at ten point height of irregularities (0.08 μm or less at center line average roughness) would lead to a considerable cost increase. Even the split-type roller has a similar cost problem.

### SUMMARY OF THE INVENTION

Tapered roller bearings for automobile are usually provided with a crowning by means of super-processing due to a large quantity of their production. However, it is difficult to make a large-sized crowning only by super-processing. On this account, if a large crowning as stated above is required, it is conceivable to use a method for firstly grinding to form the crowning and then super-processing the crowning. However, special equipment is required to perform super-processing on the whole surface having a large crowning, resulting in a substantial cost increase.

Meanwhile, even if super-processing is partially performed not in whole so as to do without special equipment, it is inevitable that the areas with no super-processing causes peeling damage on the raceway surface, thereby making the bearing life shorter.

The present invention is suitable for a tapered roller bearing for supporting an automobile transmission pilot part, and aims to provide at low cost a long-life tapered roller bearing having rollers with a large crowning.

In order to solve the aforesaid problems, the present invention provides a tapered roller bearing having tapered rollers each of which is crowning-processed by grinding and finished by barrel polishing or tumble polishing so as to leave no grinding streaks on the surface (a first aspect of the present invention).

Barrel polishing or tumble polishing may be done in any manner, not limited to a specific one. For example, barrel polishing may be of fluid type, centrifugal type, vibratory type or rotary type. In addition, MoS₂-based coating may be used together with barrel polishing or tumble polishing (a second aspect of the present invention).

Moreover, the present invention provides a method for processing rollers of a tapered roller bearing each of which is crowning-processed by grinding and finished by barrel polishing or tumble polishing so as to leave no grinding streaks on the surface (a third aspect of the present invention).

In practicing this processing method, MoS₂-based coating may be applied concurrently with barrel polishing or tumble polishing (a fourth aspect of the present invention).

The tapered roller bearing of the present invention is suitable for supporting an automobile transmission pilot part, and as a matter of course, it can be also used for other purposes.

It is possible to provide a skew-resistant tapered roller bearing at low cost without causing any problem such as short life and damage resulting from peeling or the like by forming a large crowning on the roller by means of grinding and finishing its surface through barrel polishing or tumble polishing, instead of super-finishing.

### BRIEF DESCRIPTION OF THE DRAWINGS

FIG. 1 is a diagram showing a flow of processing of a tapered roller.

FIG. 2 is a diagram showing the result of a peeling test with a tapered roller bearing.

FIG. 3 is a cross section view of a tapered roller bearing for supporting a typical automobile transmission pilot part.

FIG. 4A is a side view of a tapered roller having a crowning, and FIG. 4B is a plane view of a tapered roller having a crowning.

### DETAILED DESCRIPTION OF THE INVENTION

The embodiment of the present invention will now be described below with reference to the accompanying drawings.

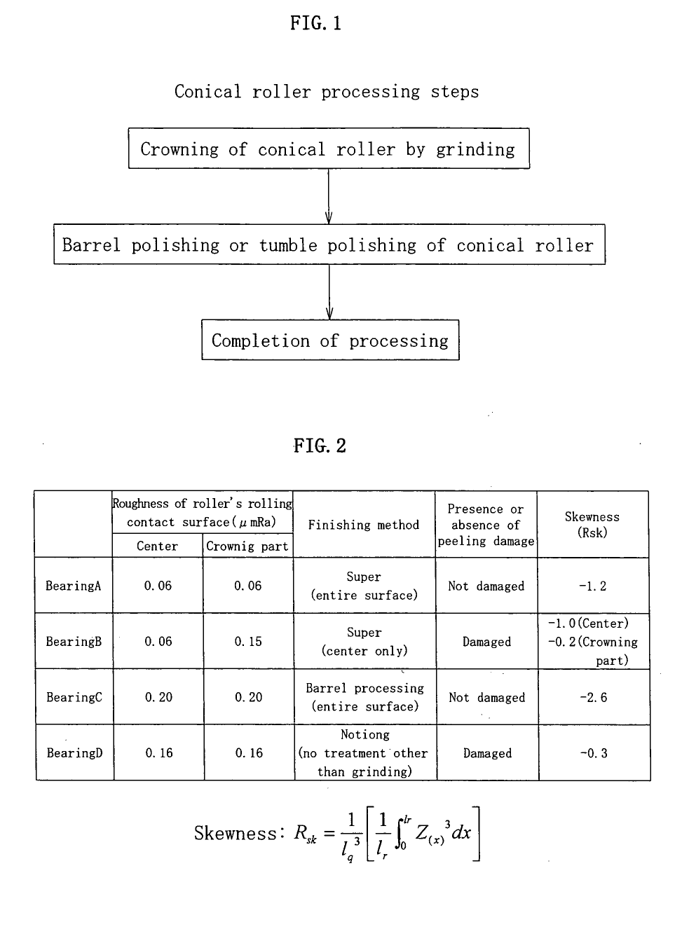

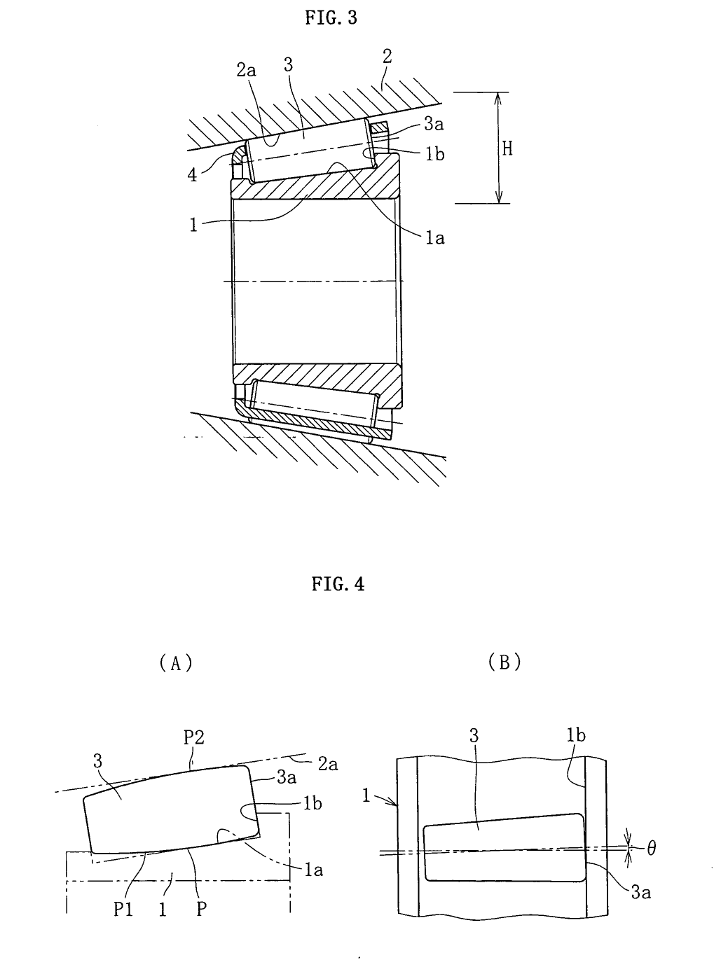

FIG. 1 shows a method for processing a roller in the tapered roller bearing of the present invention. Firstly, the tapered roller is crowning-processed by grinding. Then, barrel polishing or tumble polishing to the surface of the crowning-processed tapered rollers is continued up to the grinding streaks disappear.

The tapered roller bearing is assembled with the use of the roller processed as stated above, and this bearing is tested for peeling damage. FIG. 2 shows the outcome of the test in which a bearing C related to the present invention is compared with bearings A, B and D tested as comparative examples under the same conditions. Each roller of the bearings A to D has the same crowning formed by grinding.

The bearing A has the roller with the entire crowning finished by super-processing. Its entire surface is favorable in roughness, but high cost is required for processing this bearing. In the bearing B, only the center of the crowning of the roller is finished by super-processing se-that some grinding streaks are left. The bearing C has the entire roller finished by barrel processing, and its entire surface is high in roughness as compared with the case of using super-processing but has no grinding lines left. The bearing D has the roller to which no treatment is applied other than crowning, and is lower in roughness than that of the bearing C but has some grinding steaks left on the entire surface.

This test has revealed that the presence of grinding streaks brings about peeling damage, and that the absence of grinding streaks causes no peeling damage even if the surface is rough.

It is presumed that peeling is caused by attacking of sharp portions of grinding streaks to the opponents, i.e., the raceway surfaces of the inner and outer rings. As support for this presumption, when the comparison of skewness (Rsk) was made, the bearing C was found to be −2.6 because its projections are flattened out by barrel processing. This means that its surface is in a depressed state (the projections of grinding streaks are rounded off). On the other hand, the bearing D was −0.3 because it had not taken any treatment other than grinding. This means that its surface is in a state in which projections and depressions are in an almost equal level (the projections of grinding streaks are sharply pointed).

In short, by providing a finish in such a manner to flatten out projections resulting from grinding by means of barrel processing, it is possible to produce at low cost a bearing having a roller with a large crowning that causes no problem such as peeling damage, etc.

Additionally, in the case of using a tapered roller bearing under insufficient lubricating conditions, coating treatment using molybdenum disulfide (MoS₂) may be done for finishing touches together with barrel polishing or tumble polishing and also in order to reduce a wearing down of the roller due to slippage resulting from misalignment. Since this coating treatment can be carried out concurrently with barrel polishing or tumble polishing, it is possible to take measure against abrasion in an inexpensive and effective manner without requiring any other additional process step.

The above description is provided only for one embodiment of the present invention. The present invention is not limited to the above embodiment, and can be modified in various manners, provided that it maintains consistency in the technical idea described in the claims.

What is claimed is:

1. A tapered roller bearing having tapered rollers being crowning-processed by grinding and finished by barrel polishing or tumble polishing so as to leave no grinding streaks.

2. The tapered roller bearing according to claim 1 having tapered rollers being given MoS₂-based coating treatment concurrently with barrel polishing or tumble polishing.

3. A method for processing rollers of a tapered roller bearing being crowning-processed by grinding and finished by barrel polishing or tumble polishing so as to leave no grinding streaks.

4. The method for processing rollers of a tapered roller bearing according to claim 3 wherein MoS₂-based coating treatment is applied concurrently with barrel polishing or tumble polishing.
